(19) United States
(12) Patent Application Publication
(10) Pub. No.: US 2020/0399177 A1
(43) Pub. Date: Dec. 24, 2020

(54) BUILDING PRODUCTS HAVING SMOOTH SURFACE TOPOGRAPHY

(71) Applicant: BORAL IP HOLDINGS (AUSTRALIA) PTY LIMITED, North Sydney (AU)

(72) Inventors: Edward F. CASSIDY, Corpus Christ, TX (US); Ying ZHANG, San Antonio, TX (US); Xi ZHANG, San Antonio, TX (US)

(73) Assignee: BORAL IP HOLDINGS (AUSTRALIA) PTY LIMITED, New South Wales (AU)

(21) Appl. No.: 16/975,547

(22) PCT Filed: Feb. 26, 2018
(86) PCT No.: PCT/IB2018/000243

§ 371 Date: Aug. 25, 2020

(51) Int. Cl. C04B 26/16; C04B 28/02

(52) U.S. Cl. CPC C04B 26/16; C04B 2111/54; C04B 28/021

(57) ABSTRACT

Disclosed herein are building products comprising a polyurethane formed by the reaction of at least one isocyanate selected from the group consisting of diisocyanates, polyisocyanates and mixtures thereof and at least one polyol in the presence of fly ash and a non-silicone surfactant, wherein, the fly ash is present in an amount from 40% to 90% by weight based on the total weight of the building product; and wherein, the non-silicone surfactant is present in an amount from 0.5% to 2.2% by weight of polyol used to form the polyurethane. The building products possess desirable surfaces that are substantially free of pinholes, while also possessing a modulus, and other properties, that is comparable to or greater than that of building products substantially free of a non-silicone surfactant. Also disclosed are methods for producing the building products.

### TECHNICAL FIELD

The subject matter described herein relates generally to building products having a high modulus and comprising polyurethane including fly ash and a non-silicone surfactant in an amount sufficient to substantially eliminate pinholes and/or voids on the surface. Also disclosed are methods for producing the building products.

### BACKGROUND

The use of building products has increased as the properties of the products often match or exceed lumber. Polymeric composite materials that contain organic or inorganic filler materials have become desirable for a variety of building uses because of their excellent mechanical properties, weathering stability, and environmental friendliness. Still, these building products can have shortcomings in terms of cosmetic appearance and structural properties.

For example, a desirable building product has a surface that is free of imperfections, such as blemishes and pinholes. A surface that is free of imperfections is suitable for further modifications, such as embossing onto the surface features, e.g., a wood grain texture. Unfortunately, the ability to control the surface topography of these types of building products can be limited because modulation of the components in the matrix to modify the surface characteristics can negatively impact the physical and mechanical properties of such building products. Additives can be incorporated into the matrix to impart different properties. However, the use of relatively high amounts of additives in the matrix can also result in unwanted effects on the physical and structural properties of the building material.

Numerous attempts have been made to reduce surface blemishes but there still remains a need to maintain or even improve the desirable physical and structural properties of the building material and at the same time produce the desired surface topography. Accordingly, the subject matter described herein addresses shortcomings in the art by providing building products having the desired surface topography as well as the desired physical and structural properties.

### BRIEF SUMMARY

Aspects of the subject matter described herein include building products and methods of making the building products.

The building product can include polyurethane formed by the reaction of at least one isocyanate selected from the group consisting of diisocyanates, polyisocyanates and mixtures thereof and at least one polyol in the presence of fly ash and a non-silicone surfactant; wherein, the fly ash is present in an amount from 40% to 90% by weight based on the total weight of the building product; wherein, the non-silicone surfactant is present in an amount from 0.5% to 2.2% by weight of the polyol(s) used to form the polyurethane; wherein the surface of the building product is substantially free of pinholes and/or surface roughness of the building product can be defined by a fine cell structure on the surface; and wherein the modulus of the building product is comparable to or greater than a building product that is substantially free of a non-silicone surfactant.

The building product can include polyurethane formed by the reaction of at least one isocyanate selected from the group consisting of diisocyanates, polyisocyanates and mixtures thereof and at least one polyol in the presence of fly ash and a non-silicone surfactant; wherein, the fly ash is present in an amount from 40% to 90% by weight based on the total weight of the building product; wherein, the non-silicone surfactant is present in an amount from 0.5% to 2.2% by weight of the polyol(s) used to form the polyurethane; wherein the surface of the building product is substantially free of pinholes and/or surface roughness of the building product can be defined by a fine cell structure on the surface; and wherein the compressive strength of the building product is comparable to or greater than a building product that is substantially free of a non-silicone surfactant.

The building product can include polyurethane formed by the reaction of at least one isocyanate selected from the group consisting of diisocyanates, polyisocyanates and mixtures thereof and at least one polyol in the presence of fly ash and a non-silicone surfactant; wherein, the fly ash is present in an amount from 40% to 90% by weight based on the total weight of the building product; wherein, the non-silicone surfactant is present in an amount from 0.5% to 2.2% by weight of the polyol(s) used to form the polyurethane; wherein the surface of the building product is substantially free of pinholes and/or surface roughness of the building product can be defined by a fine cell structure on the surface; and wherein the flexural strength of the building product is comparable to or greater than a building product that is substantially free of a non-silicone surfactant.

The subject matter described herein is also directed to methods of preparing the building products.

These and other aspects of the subject matter described herein are disclosed in more detail in the description of the subject matter given below.

### BRIEF DESCRIPTION OF THE FIGURES

FIG. 1 depicts the data on the flexural strength of building products comprising a foamed polyurethane and containing the following amounts of a non-silicone surfactant: 0% (Sample 1); 0.5%; 1.0% and 2.0%. The data show that at 0.5%, the flexural strength is similar to Sample 1; at 1.0%, the flexural strength is lower than Sample 1; and at 2.0%, the flexural strength is increased compared to Sample 1. Sample 1 is a building product having the same composition as the tested products except it is free of a non-silicone surfactant.

FIG. 2 depicts the data on the modulus of building products comprising a foamed polyurethane and containing the following amounts of a non-silicone surfactant: 0% (Sample 1); 0.5%; 1.0% and 2.0%. The data show that at 0.5%, the modulus is lower as compared to Sample 1; at 1.0%, the modulus is greater as compared to Sample 1; and at 2.0%, the modulus is greater as compared to Sample 1.

FIG. 3 depicts the data on the compressive strength of building products comprising a foamed polyurethane and containing the following amounts of a non-silicone surfactant: 0% (Sample 1); 0.5%; 1.0% and 2.0%. The data show that at 0.5%, 1.0%, and 2.0%, the compressive strength is comparable to Sample 1.

FIG. 4 is a photograph showing the surface topography of building product Sample 1; building product having 0.5% non-silicone surfactant; building product having 1.0% non-silicone surfactant; and building product having 2.0% non-silicone surfactant. The photograph shows that the 1.0% and 2.0% samples exhibit the desired topography. The 0.5% sample contains noticeable pinholes and is not marketable.

FIGS. 5A, B, C and D are scanning electron micrographs at 50× magnification of building product Sample 1; building product comprising 0.5% non-silicone surfactant; building product comprising 1.0% non-silicone surfactant; and building product comprising 2.0% non-silicone surfactant. Blemishes for product containing 0.5% non-silicone surfactant are significantly less than 0% (Sample 1), and cell structure of product containing 0.5% non-silicone surfactant is substantially more uniform than 0% (Sample 1).

FIGS. 6A, B, C and D are scanning electron micrographs at 100× magnification of building product Sample 1; building product comprising 0.5% non-silicone surfactant; building product comprising 1.0% non-silicone surfactant; and building product comprising 2.0% non-silicone surfactant. Blemishes for product containing 0.5% non-silicone surfactant are significantly less than 0% (Sample 1), and cell structure of product containing 0.5% non-silicone surfactant is substantially more uniform than 0% (Sample 1).

FIGS. 7A, B, C and D are scanning electron micrographs at 200× magnification of building product Sample 1; building product comprising 0.5% non-silicone surfactant; building product comprising 1.0% non-silicone surfactant; and building product comprising 2.0% non-silicone surfactant. Blemishes for product containing 0.5% non-silicone surfactant are significantly less than 0% (Sample 1), and cell structure of product containing 0.5% non-silicone surfactant is substantially more uniform than 0% (Sample 1).

### DETAILED DESCRIPTION

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims.

Described herein are foamed polyurethane building products having desired surface characteristics and desired physical and structural properties. Unexpectedly, the addition of relatively high amounts of non-silicone surfactants into the polyurethane resulted in reduction or elimination of undesirable surface characteristics (e.g., surface pinholes and/or surface blemishes) in the building products while at the same time maintaining or improving flexural strength, modulus, and compressive strength. It has been found that the addition of up to 2.2% non-silicone surfactants by weight of the polyol(s) used to form the polyurethane provides finer cell structure of the foam, and the percentage of open cell is reduced. However, recent studies have shown that polyurethane foams with finer cell structure underperform mechanically and structurally as compared to those with coarser cell structure. Accordingly, the addition of higher levels of surfactant would be expected to negatively impact mechanical properties (e.g., flexural strength, modulus and compressive strength).

Yet, advantageously it has been found that while obtaining the desired surface characteristics, the desired mechanical properties, such as flexural strength, modulus and compressive strength of the foamed polyurethane building products are improved to a great extent or at least maintained, which is a significant benefit compared to silicone-based surfactants. Additionally, the level of surfactants used can also modulate hydrolytic stability and insulation (low K-factors).

### I. Definitions

The term “polyurethane” refers to a material comprising at least partially of a polyurethane component, or in embodiments, consisting essentially of a polyurethane component as the sole polymer component. The polyurethane can include 20% to 60% polyurethane and from 40% to 80% other polymer or non-polymer components. These components are described elsewhere herein.

An “engineered shape” refers to a configuration of the building products that is formed the processes described herein. As used herein, the term “substantially free” refers to an amount that can be present in trace quantities or less or occur at a low rate that do not materially affect the product. The term “essentially free” refers to amounts that are lower than substantially free and can be 0% to an amount that is present below routine detection.

As used herein, “comparable” refers to a property of the building product being no less than 10% of the corresponding property of a building product that is substantially free of a non-silicone surfactant.

As used herein, the term “contacting” refers to a process where two or more components are allowed to be in such proximity that the components are in physical communication.

Additional definitions may be provided elsewhere herein.

### II. Building Products

The subject matter described herein is directed to polyurethane building products, also referred to herein as building products, comprising a polyurethane and a non-silicone surfactant.

The subject matter described herein is directed to a building product comprising:

a polyurethane formed by the reaction of at least one isocyanate selected from the group consisting of diisocyanates, polyisocyanates and mixtures thereof and at least one polyol in the presence of fly ash and a non-silicone surfactant;

wherein, the fly ash is present in an amount from 40% to 90% by weight based on the total weight of the building product; and

wherein, the non-silicone surfactant is present in an amount from 0.5% to 2.2% by weight of the polyol(s) used to form the polyurethane;

wherein the surface of the building product is substantially free of pinholes; and

wherein a physical property, such as the modulus, the flexural strength and/or the compressive strength of the building product is/are comparable to or greater than a building product that is substantially free of a non-silicone surfactant.

The subject matter described herein includes building products comprising: polyurethane comprising fly ash and a non-silicone surfactant, wherein, the fly ash is present in an amount from 40% to 90% by weight based on the total weight of the building product; and wherein, the non-silicone surfactant is present in an amount from 0.5% to 2.2% by weight of the polyol(s) used to form the polyurethane; wherein a surface roughness of the building product is; and wherein a physical property of the building product is comparable to a building product substantially free of a non-silicone surfactant. The physical property can include compressive strength, elastic modulus and/or flexural strength as described elsewhere herein.

The building products described herein have desirable surfaces. Often in the manufacture of foamed polyurethanes, the surface of the foam is not suitable for a finished building product. That is, generally the surface will contain surface voids or pinholes. These defects are also found below the surface such that further sanding, planing, etc. will not result in the desired surface. What is desired is a building product that is at least substantially free of pinholes at the time of preparations.

Production of fine cell structure may be accomplished with surfactants. However, while surfactants can be used to lower the surface tension and stabilize the foam and produce a finer cell structure, such a finer cell structure has been associated with compromised physical and structural properties. Nevertheless, to obtain the desired surfaces that are substantially free of pinholes or essentially free of pinholes, it has been found that high levels of non-silicone surfactant, up to 2.2%, in the polyurethane is useful. Unexpectedly, these building products have been found to possess desired physical and structural properties as described herein. This results in a surface that is amenable to a final building product or that can be embossed with designs.

The non-silicone surfactant can be present in an amount of up to 2.2% by weight of the polyol(s) used to form the polyurethane. The non-silicone surfactant can be present in an amount from 0.5% to 2.2% by weight of the polyol(s) used to form the polyurethane. The non-silicone surfactant can be present in an amount from 1.0% to 2.0% by weight of the polyol(s) used to form the polyurethane. The non-silicone surfactant can be present in an amount from 1.8% to 2.0% by weight of the polyol(s) used to form the polyurethane. The non-silicone surfactant can be present in an amount equal to or greater than 2.0% by weight of the polyol(s) used to form the polyurethane.

The non-silicone surfactant is selected from the group consisting of non-ionic non-silicone surfactant, anionic non-silicone surfactant, cationic non-silicone surfactant, ampholytic non-silicone surfactant, semi-polar non-silicone surfactant, zwitterionic non-silicone surfactant, or combinations thereof. The non-silicone surfactant can be a non-ionic non-silicone surfactant. The non-ionic silicone surfactant can comprise Dibutylmaleate-N-vinyl-2-pyrrolidinone, in particular, equal to or greater than 25%, or equal to or greater than 35% Dibutylmaleate-N-vinyl-2-pyrrolidinone. The building product can be substantially free of a silicone surfactant.

The building product can be essentially free of a silicone surfactant.

Useful anionic surfactants include organic sulfuric reaction product having in its molecular structure an alkyl group containing from 8 to 22 carbon atoms and a sulfonic acid or sulfuric acid ester group, or mixtures thereof. Examples are the alkyl sulfates, especially those obtained by sulfating the higher alcohols having 8-18 carbon atoms produced from the glycerides of tallow or coconut oil; and alkyl benzene sulfonates. Other anionic surfactants include the alkyl glyceryl ether sulfonates, especially those ethers of higher alcohols derived from tallow and coconut oil; coconut oil fatty acid monoglyceride sulfonates and sulfates; and alkyl phenol ethylene oxide ether sulfates containing from 1 to 10 units of ethylene oxide per molecule and wherein the alkyl groups contain from 8 to 12 carbon atoms. Other useful anionic surfactants include the esters of α-sulfonated fatty acids containing from 6 to 20 carbon atoms in the ester group; 2-acyloxyalkane-1-sulfonic acids containing from 2 to 9 carbon atoms in the acyl group and from 9 to 23 carbon atoms in the alkane moiety; alkyl ether sulfates containing from 10 to 20 carbon atoms in the alkyl group and from 1 to 30 moles of ethylene oxide; olefin sulfonates containing from 12 to 24 carbon atoms; and β-alkyloxy alkane sulfonates containing from 1 to 3 carbon atoms in the alkyl group and from 8 to 20 carbon atoms in the alkane moiety. Useful water-soluble anionic organic surfactants include linear alkyl benzene sulfonates containing from 10 to 18 carbon atoms in the alkyl group; branched alkyl benzene sulfonates containing from 10 to 18 carbon atoms in the alkyl group; the tallow range alkyl sulfates; the coconut range alkyl glyceryl sulfonates; alkyl ether(ethoxylated)sulfates wherein the alkyl moiety contains from 12 to 18 carbon atoms and wherein the average degree of ethoxylation varies between 1 and 12; the sulfated condensation products of tallow alcohol with from 3 to 12, moles of ethylene oxide; and olefin sulfonates containing from 14 to 16 carbon atoms.

The nonionic surfactants can be prepared typically by condensing ethylene oxide with an —OH containing hydrocarbyl moiety, e.g., an alcohol or alkyl phenol, under conditions of acidic or basic catalysis.

Non-limiting examples of suitable water-soluble nonionic surfactants include the ethylene oxide condensates of alkyl phenols. These compounds include the condensation products of alkyl phenols having an alkyl group containing from 6 to 18 carbon atoms in either a straight chain or branched chain configuration, with EO, said EO being present in amounts from 3 to 25 moles of EO per mole of alkyl phenol. The alkyl substituent in such compounds can be derived, for example, from polymerized propylene, diisobutylene, octene, or nonene. Examples of compounds of this type include nonyl phenol condensed with 9.5 moles of EO per mole of nonyl phenol; dodecyl phenol condensed with 12 moles of EO per mole of phenol; dinonyl phenol condensed with 15 moles of EO per mole of phenol; and di-isooctylphenol condensed with 15 moles of EO per mole of phenol. The condensation products of aliphatic alcohols with ethylene oxide are another type of nonionic surfactant used herein. Examples of such ethoxylated alcohols include the condensation product from 6 moles of EO with 1 mole of tridecanol; myristyl alcohol condensed with 10 moles of EO per mole of myristyl alcohol; the condensation product of EO with coconut fatty alcohol wherein the coconut alcohol is primarily a mixture of fatty alcohols with alkyl chains varying from 10 to 14 carbon atoms in length and wherein the condensate contains 6 moles of EO per mole of total alcohol; and the condensation product of 9 moles of EO with the above-described coconut alcohol. Tallow alcohol ethoxylates (EO)₆ to (EO)₁₁ are similarly useful herein. The condensation products of ethylene oxide with a hydrophobic base formed by the condensation of propylene oxide with propylene glycol constitute another type of nonionic surfactant. The hydrophobic portion of these compounds has a molecular weight of from 1500 to 18000 and, of course, exhibits water insolubility. The addition of poly-EO moieties to this hydrophobic portion tends to increase the water-solubility of the molecule as a whole, and the liquid character of the product is retained up to the point where the EO content is 50% of the total weight of the condensation product. The condensation products of ethylene oxide with the product resulting from the reaction of propylene oxide and ethylenediamine are another type of nonionic surfactant useful herein. The hydrophobic “base” of these condensation products consists of the reaction product of ethylenediamine and excess propylene oxide, said base having a molecular weight from 2500 to 3000. This base compound is thereafter condensed with EO to the extent that the condensation product contains from 40 to 80% by weight of poly-EO and has a molecular weight of from 5,000 to 11,000. The nonionic surfactants herein include the EO₁-EO₂₀ condensates of C₉ to C₁₈ primary and secondary alcohols; the condensates of primary alcohols are most preferred. Non-limiting, specific examples of nonionic surfactants of this type are as follows (the abbreviations used for the nonionic surfactants, e.g., C₁₄(EO)₆, are standard for such materials and describe the carbon content of the lipophilic portion of the molecule and the ethylene oxide content of the hydrophilic portion): n-C₁₄H₂₉(EO)₅; n-C₁₄H₂₉(EO)₆; n-C₁₄H₂₉(EO)₇; n-C₁₄H₂₉(EO)₁₀; n-C₁₅H₃₁(EO)₆; n-C₁₅H₃₁(EO)₇; ₂-C₁₅H₃₁(EO)₇; n-C₁₅H₃₁(EO)₈; 2-C₁₅H₃₁(EO)₈; n-C₁₅H₃₁(EO)₉; 2-C₁₅H₃₁(EO)₉; n-C₁₆H₃₃(EO)₉; and 2-C₁₆H₃₃(EO)₉. Mixtures of the foregoing nonionic surfactants are also useful. It will be appreciated that the degree of ethoxylation in the nonionics listed herein can vary.

Particularly useful non-ionic non-silicone surfactants include salts of sulfonic acids, such as alkali metal salts of fatty acids, ammonium salts of fatty acids, such as oleic acid, stearic acid, dodecylbenzenedidulfonic acid, dinaphthylmethanedisulfonic acid, ricinoleic acid, oxyethylated alkylphenols, oxyethylated fatty alcohols, paraffin oils, castor oil esters, ricinoleic acid esters, Turkey red oil, groundnut oil, paraffins and fatty alcohols, and combinations thereof.

Useful cationic surfactants may be quaternary ammonium halide and analogous phosphonium compounds. The quaternary ammonium halides include myristyl trimethylammonium bromide, lauryl trimethylammonium bromide, cetyl trimethylammonium bromide, myristyl trimethylammonium chloride, lauryl trimethylammonium chloride and cetyl trimethylammonium chloride.

Other surfactants are the semi-polar, ampholytic, and zwitterionic surfactants known in the art. Semi-polar surfactants useful herein include water-soluble amine oxides containing one alkyl moiety of from 10 to 28 carbon atoms and two moieties selected from the group consisting of alkyl moieties and hydroxyalkyl moieties containing from 1 to 3 carbon atoms; water-soluble phosphine oxides containing one alkyl moiety from 10 to 28 carbon atoms and two moieties selected from the group consisting of alkyl moieties and hydroxyalkyl moieties containing from 1 to 3 carbon atoms; and water-soluble sulfoxides containing one alkyl moiety of from 10 to 28 carbon atoms and a moiety selected from the group consisting of alkyl and hydroxyalkyl moieties of from 1 to 3 carbon atoms. Ampholytic surfactants include derivatives of aliphatic or aliphatic derivatives of heterocyclic secondary and tertiary amines in which the aliphatic moiety can be straight chain or branched and wherein one of the aliphatic substituents contains from 8 to 18 carbon atoms, and at least one aliphatic substituent contains an anionic water-solubilizing group. Zwitterionic surfactants include derivatives of aliphatic quaternary ammonium, phosphonium and sulfonium compounds in which the aliphatic moieties can be straight or branched chain, and wherein one of the aliphatic substituents contains from 8 to 18 carbon atoms and one contains an anionic water solubilizing group.

The building product having the desired properties, including surface characteristics also can have a modulus that is comparable to or greater than that of a comparator building product that is substantially free of a non-silicone surfactant. The building product having the desired surface characteristics also can have a modulus of above 16 ksi. The building product having the desired surface characteristics also can have a modulus from 16 to 17 ksi. The building product can have a modulus that is equal to or greater than 3% higher as compared to a building product that is substantially free of a non-silicone surfactant. The building product having the desired surface characteristics also can have a modulus that is from 3% to 7% higher as compared to a comparator building product containing no non-silicone surfactant. The building product having the desired surface characteristics also can have a modulus that is from 5% to 7% higher as compared to a comparator building product containing no non-silicone surfactant.

The building product having desired properties, including surface characteristics also can have a flexural strength that is comparable to or greater than that of a comparator building product that is substantially free of a non-silicone surfactant. The building product having the desired surface characteristics also can have a flexural strength from 200 to 350 psi. The building product having the desired surface characteristics also can have a flexural strength from 250 to 325 psi. The building product having the desired surface characteristics also can have a flexural strength of equal to or greater than 290 psi. The building product having the desired surface characteristics also can have a flexural strength that is greater as compared to a building product containing no non-silicone surfactant.

The building product having desired properties, including surface characteristics also can have a compressive strength that is comparable to or greater than that of a comparator building product that is substantially free of a non-silicone surfactant. The building product can have a compressive strength that is greater as compared to a comparator building product containing no non-silicone surfactant. The building product can have a compressive strength that is comparable to a comparator building product containing no non-silicone surfactant. The compressive strength can be from 250 to 350 psi. The compressive strength can be from 300 to 350 psi. The compressive strength can be equal to or greater than 325 psi.

The building product having desired properties, including surface characteristics also can have a K-factor that is comparable or lower to a comparator building product that is substantially free of a non-silicone surfactant, or essentially free of a non-silicone surfactant.

The polyurethane system can be the sole polymer in the matrix of the building product.

The polyurethane can be formed by the reaction of an isocyanate (such as diisocyanates and polyisocyanates), a polyol, and fly ash. In embodiments, the polyurethane is foamed, e.g., those described in WO 2016/195717; U.S. Pat. No. 7,879,144; U.S. 2014/0349104; U.S. 2010/0292397, each of which is incorporated herein by reference in its entirety. The polyurethane can be based on a polyether or polyester based polyol and a diisocyanates or polyisocyanates that include MDI, PMDI, TDI or alkyl isocyanates. The polyol can contain an aromatic content and can incorporate a Mannich derived polyol(s).

The building products contain a filled polyurethane foam. The foam can be prepared by combining approximately equal amounts of MDI and polyol. The formula ratio can be biased in order to produce an under or over indexed polyurethane foam. The foam can comprise from 40% to 90% fly ash by weight of the building product, or from 40% to 60% fly ash by weight of the building product, or in an amount of 50% fly ash by weight of the building product. The foamed polyurethane can contain other fillers described elsewhere herein, such as, calcium carbonate, talc, etc. In addition to these three components, to prepare the foam polyurethane, a material is added to produce a gas which is trapped in the polyurethane which serves to lower the density. This material can be water which reacts with MDI to produce carbon dioxide, or a low boiling point—high vapor pressure solvent/refrigerant that is a gas at the processing temperature of the polyurethane. Several mixing technologies are compatible with this system and the selection of the mixing technology is dependent on the whether a continuous or non-continuous process is desired as well as the process rate.

The building products can have an engineered shape. The building product can be molded from a master mold. The cavity of the master mold can have any shape desired. The building product prepared from such a mold will mimic the shape of the cavity of the mold. The molding will occur for a set time, which can be determined and adjusted by those of skill in this field and will depend on the chemistry of the polyurethane. After molding for a set time, the foamed polyurethane can have the desired thickness and planarity or the foamed polyurethane can further be shaped by machining, slicing, cutting, sanding, planing, trimming and the like to prepare a three-dimensional building product having the desired engineered shape.

The surface, being substantially free of voids and pinholes can have designs, contours and patterns, such as grains that mimic wood or other natural products. The surface can also be embossed. Examples of such engineered shapes include synthetic stone, roofing tiles (e.g., shake and slate tile), ceramic tiles, architectural stone, beadboard, thin bricks, bricks, pavers, panels, boards (e.g., backer board layers), underlay (e.g., bathroom underlay), banisters, lintels, pipe, posts, siding, signs, guard rails, retaining walls, park benches, tables, trim, railroad ties, and other shaped articles. Shapes include panels that resemble stucco, cement, stone, or brick. Particular shapes include sheets, boards and blocks. An exemplary shape is a board, having the desired dimensions for use as a building product.

The building product can have dimensions including those of a board or plank, e.g., 5 inches to 3 feet (width)×4 feet to 16 feet (length)×0.5 inches to 3 inches. (thickness).

In embodiments, the density of the building product is from 12 pcf to 20 pcf; from 13 pcf to 19 pcf; from 14 pcf to 18 pcf; from 15 pcf to 17 pcf; or is 12 pcf, 13 pcf, 14 pcf, 15 pcf, 16, 17 pcf 18 pcf, 19 pcf or 20 pcf, or greater than 20 pcf to less than 60 pcf.

While foaming agents and blowing agents can be added to produce the building product, in particular embodiments, the polyurethane matrices that form the building products do not contain a halogenated hydrocarbon. Examples of blowing agents include organic blowing agents, such as halogenated hydrocarbons, acetone, hexanes, and other materials that have a boiling point below the reaction temperature. Chemical foaming agents include azodicarbonamides, and other materials that react at the reaction temperature to form gases such as carbon dioxide. Water is an exemplary foaming agent that reacts with isocyanate to yield carbon dioxide. The presence of water as an added component or in the filler also can result in the formation of polyurea bonds through the reaction of the water and isocyanate. Water can be present in the mixture used to produce the building product in an amount of from greater than 0% to less than 5% by weight, based on the weight of the mixture. Water can be present in a range of 0.02% to 4%, 0.05% to 3%, 0.1% to 2%, or 0.2% to 1% by weight, based on the weight of the mixture. The mixture used to produce the building product can include less than 0.5% by weight water.

The building product can be essentially free of fiber materials. However, when fibers are present, the fibers selected can include those described in WO 2016/195717, incorporated herein by reference in its entirety. The fiber material can be present in the building product in amounts from 0.5% to 20% by weight, based on the weight of the building product. For example, the fiber material (when used) can be present in amounts from 1% to 10%, 1.5% to 8%, 2% to 6%, or 2% to 4% by weight, based on the weight of the building product. A fiber material can be included in the building product, e.g., to provide increased strength, stiffness or toughness. The fiber material can be any natural or synthetic fiber material, based on inorganic materials, organic materials, or combinations of both. Fiber materials suitable for use with the building product can be present in the form of individual fibers, fabrics, rovings, or tows. Exemplary fiber materials that can be used in the building product include glass fibers and mineral wool fibers such as stone wool, slag wool, or ceramic fiber wool. The mineral wool fibers can be synthetic or can be obtained from molten mineral such as lava, rock or stone. Other suitable inorganic fiber materials include basalt fibers, wollastonite fibers, alumina silica fibers, aluminum oxide fibers, silica fibers, carbon fibers, metal fibers, and combinations thereof. Exemplary organic fiber materials that can be used in the building product include hemp fibers, sisal fibers, cotton fibers, straw, reeds, or other grasses, jute, bagasse fibers, abaca fibers, flax, southern pine fibers, wood fibers, cellulose, saw dust, wood shavings, lint, vicose, leather fibers, rayon, and mixtures thereof. Other suitable organic fiber materials include synthetic fibers such as, Kevlar, viscose fibers, polyamide fibers, polyacrylonitrile fibers, DRALON® fibers, polyethylene fibers, polypropylene fibers, polyvinyl alcohol fibers, polyacrylic fibers, polyester fibers, aramid fibers, carbon fibers, or combinations thereof. In some embodiments, the building products can include a combination of fibers that break and fibers that do not break when the composite is fractured by external stress. Yet other fibers, such as specific glass fibers, are described elsewhere herein.

Fibers include glass fibers, such as E-glass, C-glass, S-glass, and AR-glass fibers. Fire resistant or retardant glass fibers can be included to impart fire resistance or retarding properties to the building products. The glass fibers can be from 1 mm to 50 mm in average length. In some examples, the glass fibers are from 1 mm to 20 mm, from 2 mm to 20 mm, from 3 mm to 20 mm, or from 3 mm to 15 mm in average length. In some examples, the average length of the glass fibers can be 1 mm or greater, 1.5 mm or greater, 2 mm or greater, 3 mm or greater, 4 mm or greater, 5 mm or greater, or 6 mm or greater. In some embodiments, the average length of the glass fibers can be 50 mm or less, 40 mm or less, 30 mm or less, 20 mm or less, 15 mm or less, 12 mm or less, or 10 mm or less. The glass fibers can be provided in a random orientation or can be axially oriented. The glass fibers can be coated with a sizing agent to modify their reactivity. The glass fibers can have any dimension of from 5 μm to 30 μm in average diameter. For example, the average diameter of the glass fibers can be 5 μm to 25 μm, 6 μm to 20 μm, 5 μm to 18 μm, or 5 μm to 15 μm in average diameter. The fiber can be fiberglass. The fiber can be chopped fiberglass. The fiberglass can have a sizing. The fiberglass can have a sizing comprising a silane. The sizing can comprise a mixture of starch and oil.

The building products can comprise additional fillers and additives known to those of skill in the art. These fillers as described elsewhere herein can modulate the properties of the building product as desired. Additional additives useful with the building products described herein include fibers, surfactants, chain-extenders, crosslinkers, coupling agents, UV stabilizers, fire retardants, antimicrobials, anti-oxidants, and pigments. The use of such components is well known to those of skill in the art, and some of these additional additives are further described elsewhere herein.

The isocyanate can be selected from the group consisting of diisocyanates, polyisocyanates, and mixtures thereof. Isocyanates useful with the polyurethanes described herein include one or more monomeric or oligomeric poly- or di-isocyanates. The monomeric or oligomeric poly- or di-isocyanate include aromatic diisocyanates and polyisocyanates. The isocyanates can also be blocked isocyanates. An example of a useful diisocyanate is methylene diphenyl diisocyanate (MDI). Useful MDIs include MDI monomers, MDI oligomers, and mixtures thereof. Further examples of useful isocyanates include those having NCO (i.e., the reactive group of an isocyanate) contents ranging from 25% to 35% by weight. Examples of useful isocyanates are found, for example, in Polyurethane Handbook: Chemistry, Raw Materials, Processing Application, Properties, 2^{nd} Edition, Ed: Gunter Oertel; Hanser/Gardner Publications, Inc., Cincinnati, Ohio, which is herein incorporated by reference. Suitable examples of aromatic polyisocyanates include 2,4- or 2,6-toluene diisocyanate, including mixtures thereof; p-phenylene diisocyanate; tetramethylene and hexamethylene diisocyanates; 4,4-dicyclohexylmethane diisocyanate; isophorone diisocyanate; 4,4-phenylmethane diisocyanate; polymethylene polyphenylisocyanate; and mixtures thereof. In addition, triisocyanates may be used, for example, 4,4,4-triphenylmethane triisocyanate; 1,2,4-benzene triisocyanate; polymethylene polyphenyl polyisocyanate; methylene polyphenyl polyisocyanate; and mixtures thereof. Suitable blocked isocyanates are formed by the treatment of the isocyanates described herein with a blocking agent (e.g., diethyl malonate, 3,5-dimethylpyrazole, methylethylketoxime, and caprolactam). Isocyanates are commercially available, for example, from Bayer Corporation (Pittsburgh, Pa.) under the trademarks MONDUR and DESMODUR. Other examples of suitable isocyanates include Mondur MR Light (Bayer Corporation; Pittsburgh, Pa.), PAPI 27 (Dow Chemical Company; Midland, Mich.), Lupranate M20 (BASF Corporation; Florham Park, N.J.), Lupranate M70L (BASF Corporation; Florham Park, N.J.), Rubinate M (Huntsman Polyurethanes; Geismar, La.), Econate 31 (Ecopur Industries), and derivatives thereof.

The average functionality of isocyanates or combinations of isocyanates is from 1.5 to 5. Further, examples of useful isocyanates include isocyanates with an average functionality of 2 to 4.5, 2.2 to 4, 2.4 to 3.7, 2.6 to 3.4, and 2.8 to 3.2.

The polyol can include, for example, polyester polyols or polyether polyols. Polyols or combinations of polyols useful with the polyurethanes described herein have an average functionality from 1.5 to 8.0. Useful polyols additionally have an average functionality from 1.6 to 6.0, 1.8 to 4.0, 2.5 to 3.5, or 2.6 to 3.1. The average hydroxyl number values for polyols useful with the polyurethanes described herein include hydroxyl numbers from 100 to 600, 150 to 550, 200 to 500, 250 to 440, 300 to 415, and 340 to 400.

The polyol can include one or more plant-based polyols. The use of plant-based polyols increases the environmental content of the composite materials. The one or more plant-based polyols can include castor oil. Castor oil is a well-known, commercially available material, and is described, for example, in Encyclopedia of Chemical Technology, Volume 5, John Wiley & Sons (1979). Suitable castor oils include those sold by Vertellus Specialities, Inc., e.g., DB® Oil, and Eagle Specialty Products, e.g., T31® Oil.

The one or more plant-based polyols described herein can include polyols containing ester groups that are derived from plant-based fats and oils. Accordingly, the one or more plant-based polyols can contain structural elements of fatty acids and fatty alcohols. Starting materials for the plant-based polyols of the polyurethane component include fats and/or oils of plant-based origin with preferably unsaturated fatty acid residues. The one or more plant-based polyols useful with the polyurethanes described herein can include, for example, castor oil; coconut oil; corn oil; cottonseed oil; lesquerella oil; linseed oil; olive oil; palm oil; palm kernel oil; peanut oil; sunflower oil; tall oil; and mixtures thereof. In some embodiments, the one or more plant-based polyols can be derived from soybean oil as the plant-based oil.

The one or more polyols can include highly reactive polyols that include a large number of primary hydroxyl groups (e.g. 75% or more or 80% or more) as determined using fluorine NMR spectroscopy as described in ASTM D4273. The highly reactive polyol can have a primary hydroxyl number, defined as the hydroxyl number multiplied by the percentage of primary hydroxyl groups based on the total number of hydroxyl groups, of greater than 250. Exemplary highly reactive polyols include plant-based polyols such as Pel-Soy 744 and Pel-Soy P-750, soybean oil based polyols commercially available from Pelron Corporation; Agrol Diamond, a soybean oil based polyol commercially available from BioBased Technologies; Ecopol 122, Ecopol 131 and Ecopol 132, soybean oil polyols formed using polyethylene terephthalate and commercially available from Ecopur Industries; Honey Bee HB-530, a soybean oil-based polyol commerically available from MCPU Layer Engineering; Renewpol, a castor oil-based polyol commercially available from Styrotech Industries (Brooklyn Park, Minn.); JeffAdd B 650, a 65% bio-based content (using ASTM D6866-06) additive based on soybean oil commercially available from Huntsman Polyurethanes (Auburn Hills, Mich.); Stepanpol PD-110 LV and PS 2352, polyols based on soybean oil, diethylene glycol and phthalic anhydride and commercially available from Stepan Company; and derivatives thereof. In some embodiments, the highly reactive plant-based polyols can be formed by the reaction of a soybean oil and a polyester to produce a plant-based polyester polyol. An example of such a soybean oil-based polyester polyol is Ecopol 131, which is a highly reactive aromatic polyester polyol comprising 80% primary hydroxyl groups. Polyester polyols can be prepared using recyclable polyester to further increase the recyclable content of an organic layer and Ecopol 131 is an example of such a polyester polyol. In some embodiments, the soybean oil and polyester based polyol can be prepared using recycled polyester. The polyol can include renewable and recyclable content.

The castor oil component when combined with a highly reactive polyol such as Ecopol 131 also provides benefits such as increased resiliency, toughness and handleability. The castor oil and highly reactive polyol can be combined in various percentages, e.g., 15-40% of the castor oil and 60-85% of the highly reactive polyol. The castor oil also can provide a polyurethane foam product that is harder to break and thus that can be used for more demanding applications.

The building products will comprise a fly ash component. The reaction of at least one isocyanate and at least one polyol can be in the presence of fly ash, resulting in a fly ash component of the building product. Fly ash is produced from the combustion of pulverized coal in electrical power generating plants. Fly ash produced by coal-fueled power plants is suitable for use in reactive powder described herein. The fly ash can include Class C fly ash, Class F fly ash, or a mixture thereof. As such, the calcium content of the fly ash can vary. The fly ash can have a calcium content, expressed as the oxide form (i.e., calcium oxide), of from 18% to 35% by weight. The calcium oxide content of the fly ash can be from 23% to 30% by weight.

The majority of the fly ash present can be Class C fly ash (i.e., greater than 50% of the fly ash present is Class C fly ash). In some examples, greater than 75%, greater than 85%, or greater than 95% of the fly ash present is Class C fly ash. For example, greater than 75%, greater than 76%, greater than 77%, greater than 78%, greater than 79%, greater than 80%, greater than 81%, greater than 82%, greater than 83%, greater than 84%, greater than 85%, greater than 86%, greater than 87%, greater than 88%, greater than 89%, greater than 90%, greater than 91%, greater than 92%, greater than 93%, greater than 94%, greater than 95%, greater than 96%, greater than 97%, greater than 98%, or greater than 99% of the fly ash present is Class C fly ash. Only Class C fly ash can be present, or blends of Class C fly ash and Class F fly ash can be used, particularly if the overall CaO content is as discussed above.

The majority of the fly ash present can be Class F fly ash (i.e., greater than 50% of the fly ash present is Class F fly ash). In some examples, greater than 75%, greater than 85%, or greater than 95% of the fly ash present is Class F fly ash. For example, greater than 75%, greater than 76%, greater than 77%, greater than 78%, greater than 79%, greater than 80%, greater than 81%, greater than 82%, greater than 83%, greater than 84%, greater than 85%, greater than 86%, greater than 87%, greater than 88%, greater than 89%, greater than 90%, greater than 91%, greater than 92%, greater than 93%, greater than 94%, greater than 95%, greater than 96%, greater than 97%, greater than 98%, or greater than 99% of the fly ash present is Class F fly ash. Class F fly ash can be the sole fly ash used.

The fly ash can be present in the building products described herein in amounts from 40% to 90% by weight, or from 40% to 80%, or from 40% to 60%. The amount of fly ash present in the organic layers described herein can be 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or 90%.

The subject matter described herein is also directed to foamed polyurethane building products comprising: a polyurethane formed by the reaction of a polyol and isocyanate having an isocyanate index of 104; water (at approximately 1 wt % of the polyol); catalyst, e.g., at approximately 0.1 wt % of the polyol; non-silicone surfactant, e.g. at 0.5-2 wt % of the polyol; and Type C fly ash at approximately 50 wt % of the total mixture. In certain aspects, the building product contains no fibers or other components.

Additional components useful with the compositions described herein are disclosed in US 2011/0086934 and WO 2016/195717, each of which is incorporated by reference in its entirety. Additional components include fillers, water reducers, plasticizers, pigments, foaming agents (e.g., air-entraining agents) or blowing agents, anti-efflorescence agents, photocatalysts, ultraviolet light stabilizers, fire retardants, antimicrobials, and antioxidants.

One or more fillers can include types of ash such as those produced by firing fuels including industrial gases, petroleum coke, petroleum products, municipal solid waste, paper sludge, wood, sawdust, refuse derived fuels, switchgrass, or other biomass material; ground/recycled glass (e.g., window or bottle glass); milled glass; glass spheres; glass flakes; activated carbon; calcium carbonate; aluminum trihydrate (ATH); silica; sand; alluvial sand; natural river sand; ground sand; crushed granite; crushed limestone; silica fume; slate dust; crusher fines; red mud; amorphous carbon (e.g., carbon black); clays (e.g., kaolin); mica; talc; wollastonite; alumina; feldspar; bentonite; quartz; garnet; saponite; beidellite; granite; calcium oxide; calcium hydroxide; antimony trioxide; barium sulfate; magnesium oxide; titanium dioxide; zinc carbonate; zinc oxide; nepheline syenite; perlite; diatomite; pyrophillite; flue gas desulfurization (FGD) material; soda ash; trona; soy meal; pulverized foam; and mixtures thereof.

Water reducers can be included in the compositions described herein to reduce the amount of water in the composition while maintaining the workability, fluidity, and/or plasticity of the building product. Examples of suitable water reducers include lignin, naphthalene, melamine, polycarboxylates, lignosulfates and formaldehyde condensates (e.g., sodium naphthalene sulfonate formaldehyde condensate). In some examples, the water reducer is a high-range water reducer, such as, for example, a superplasticizer. Standard plasticizers can also be included in the compositions described herein. Examples of suitable plasticizers for use with the compositions described herein include clays (e.g., bentonite, expanded clay, and kaolin clay), and JEFFSPERSE X3202, JEFFSPERSE X3202RF, and JEFFSPERSE X3204, each commercially available from Huntsman Polyurethanes; Geismar, La. Water reducers can be provided in an amount of 0.01% to 6% based on the weight of the building product. For example, the water reducers can be included in an amount of 0.05% to 5%, 0.1% to 4%, or 0.5% to 3% based on the weight of the building product.

Pigments or dyes can optionally be added to the building products described herein.

As discussed elsewhere herein, the foamed polyurethane building products contain up to 2.2% non-silicone surfactant by weight of the polyol(s) used to form the polyurethane. Additional surfactants other than non-silicone surfactants can be used. These can act as wetting agents and to assist in mixing and dispersing the materials in a composite. Surfactants can also stabilize and control the size of bubbles formed during the foaming event and the resultant cell structure. Generally, these surfactants can be used, for example, in amounts below 0.5 wt % based on the total weight of the mixture. Examples of surfactants useful with the polyurethanes described herein include anionic, non-ionic and cationic surfactants. For example, silicone surfactants such as Tegostab B-8870, DC-197 and DC-193 (Air Products; Allentown, Pa.) can be used. The building products contain a non-silicone surfactant but do not contain an additional surfactant. The foamed polyurethane building product can be substantially free of silicone surfactant. The foamed polyurethane building product can be essentially free of silicone surfactant.

Low molecular weight reactants such as chain-extenders and/or crosslinkers can be included in the composite described herein. These reactants help the polyurethane system to distribute and contain the fillers, fibers, etc., within the polyurethane. Chain-extenders are (functional molecules, such as diols or diamines, which can polymerize to lengthen the urethane polymer chains. Examples of chain-extenders include ethylene glycol; 1,4-butanediol; ethylene diamine, 4,4′-methylenebis(2-chloroaniline) (MBOCA); diethyltoluene diamine (DETDA); and aromatic diamines such as Unilink 4200 (commercially available from UOP). Crosslinkers are tri- or greater functional molecules that can integrate into a polymer chain through two functionalities and provide one or more further functionalities (i.e., linkage sites) to crosslink to additional polymer chains. Examples of crosslinkers include glycerin, trimethylolpropane, sorbitol, diethanolamine, and triethanolamine A crosslinker or chain-extender may be used to replace at least a portion of the one or more polyol in the polyurethane. For example, the polyurethane can be formed by the reaction of an isocyanate, a polyol, and a crosslinker.

Coupling agents and other surface treatments such as viscosity reducers, flow control agents, or dispersing agents can be added directly to the filler or fiber, or incorporated prior to, during, and/or after the mixing and reaction of the polyurethane. Coupling agents can allow higher filler loadings of the particulate filler such as fly ash and/or the lightweight filler and may be used in small quantities. For example, the composite material may comprise from 0.01 wt % to 0.5 wt % of a coupling agent. Examples of coupling agents useful with the building products described herein include Ken-React LICA 38 and KEN-React KR 55 (Kenrich Petrochemicals; Bayonne, N.J.). Examples of dispersing agents useful with the composite materials described herein include JEFFSPERSE X3202, JEFFSPERSE X3202RF, and JEFFSPERSE X3204 (Huntsman Polyurethanes; Geismar, La.).

Ultraviolet (UV) light stabilizers, such as UV absorbers, can be added to the building products described herein. Examples of UV light stabilizers include hindered amine type stabilizers and opaque pigments like carbon black powder. Fire retardants can be included to increase the flame or fire resistance of the building products. Antimicrobials, such as copper complexes, can be used to limit the growth of mildew and other organisms on the surface of the building products. Antioxidants, such as phenolic antioxidants, can also be added. Antioxidants can provide increased UV protection, as well as thermal oxidation protection.

### III. Methods of Manufacture

Described herein are methods of producing foamed polyurethane building products having desirable characteristics including surface topography and physical and structural properties. The methods described herein include methods of producing the building product of any above embodiment, comprising: contacting an isocyanate and a polyol, in the presence of fly ash and 0.5% to 2.2% non-silicone surfactant by weight of the polyol, and optionally other additives and fillers, to prepare a mixture; extruding the mixture into a mold; and curing the mixture to obtain the building product. The methods can further comprise shaping the foamed polyurethane building product.

The polyurethane can be prepared by those of skill in the art following methods known in the art. The polyurethane can be prepared using the following techniques: extrusion, casting, injection molding, calendaring, blow molding, compression molding, thermoforming, and vacuum forming. In the case of polyurethanes, they can be formed in accordance with certain techniques. For example, polyurethanes can be prepared using the methods disclosed in U.S. Pat. Nos. 9,512,288; 7,879,144; U.S. 2011/0086934; and U.S. 2014/0349104, each of which is incorporated by reference in its entirety.

The polyurethane can be formed by the reaction of one or more isocyanate, selected from the group consisting of diisocyanates, polyisocyanates, and mixtures thereof, and one or more polyol, in the presence from 0.5% to 2.2% non-silicone surfactant, and optionally any filler, additive, and/or a catalyst. The polyurethane can be produced by mixing the one or more isocyanates, the one or more polyols, the non-silicone surfactant, filler, etc., in a mixing apparatus such as a high speed mixer or an extruder. Mixing can be conducted in an extruder. The materials can be added in any suitable order. For example, the mixing stage of the method used to prepare the polyurethane can include a non-silicone surfactant and mixing the polyol, and any filler, mixing the isocyanate with the polyol, and any filler, and optionally mixing the catalyst with the isocyanate, the polyol, and any filler. Fillers can be added at the same time, or can be added at different stages or the same stage, e.g., prior to, during, or after any stage. The methods and the foamed polyurethane building products made therefrom may not contain a silicone surfactant.

The polyurethane can be blended in any suitable manner to obtain a homogeneous or heterogeneous blend of the one or more isocyanate, one or more polyol, any fillers and optional catalyst. An ultrasonic device can be used for enhanced mixing and/or wetting of the various components that compose the matrix. The ultrasonic device produces an ultrasound of a certain frequency that can be varied during the mixing and/or extrusion process. The ultrasonic device useful in the preparation of the products described herein can be attached to or adjacent to an extruder and/or mixer. For example, the ultrasonic device can be attached to a die or nozzle or to the port of an extruder or mixer. An ultrasonic device may provide de-aeration of undesired gas bubbles and better mixing for the other components, such as blowing agents, surfactants, and catalysts.

The mixture can be provided (e.g., fed or extruded) into a mold cavity of a mold, the mold cavity formed by at least an interior mold surface. The extrusion can include a top-down method of filling the mold. The mold can be a continuous forming system such as a belt molding system or can include individual batch molds. The belt molding system can include a mold cavity formed at least in part by opposing surfaces of two opposed belts. A molded article can then be formed followed by removal of the article from the mold to prepare the building product.

The polyurethane may be processed at an elevated temperature (e.g., 200-500° F.) to form a melt and to allow the mixture to have a workable viscosity. In some embodiments, any filler(s) are heated before mixing with the polyurethane. The molten filled polyurethane (that is, the polyurethane, and any fillers) can have a workable viscosity of 25 Pa*s to 250 Pa*s. The viscosity of the mixture can be measured using a Thermo Electron Corporation Haake Viscometer.

The polyol and the isocyanate can be allowed to produce a foamed polyurethane after mixing the components according to the methods described herein. The matrix can be formed while they are actively foaming or after they have foamed. For example, the material can be placed under the pressure of a mold cavity prior to or during the foaming of the material that will compose the core.

In some embodiments, the methods form a matrix that is substantially free or essentially free of a blowing or foaming agent other than water. In particular, the foamed polyurethane building material has fine cell structures that are essentially a closed cell system.

### IV. Specific Embodiments

The subject matter described herein includes, but is not limited to, the following specific embodiments:

1. A building product comprising:

polyurethane comprising fly ash and a non-silicone surfactant,

wherein, the fly ash is present in an amount from 40% to 90% by weight based on the total weight of the building product; and

wherein, the non-silicone surfactant is present in an amount from 0.5% to 2.2% by weight of the polyol(s) used to form the polyurethane;

wherein a surface roughness of the building product can be defined by a fine cell structure on the surface; and

wherein the modulus of the building product is comparable to a building product substantially free of a non-silicone surfactant.

2. The building product of embodiment 1, wherein the polyurethane comprises fine closed-cell structure.
3. The building product of any above embodiment, wherein the non-silicone surfactant is present in an amount from 0.7% to 2.0% by weight of the polyol(s) used to form the polyurethane.
4. The building product of any above embodiment, wherein the non-silicone surfactant is present in an amount of from 1.0% to 2.0% by weight of the total building product.
5. The building product of any above embodiment, wherein the building product has a modulus of from 16 to 17 ksi.
6. The building product of any above embodiment, wherein the building product has a modulus that is from 3% to 7% higher as compared to a building product containing no non-silicone surfactant.
7. The building product of any above embodiment, wherein the building product has a modulus that is from 5% to 7% higher as compared to a building product containing no non-silicone surfactant.
8. The building product of any above embodiment, wherein the building product has a flexural strength of from 200 to 350 psi.
9. The building product of any above embodiment, wherein the building product has a flexural strength of 250 to 300 psi.
10. The building product of any above embodiment, wherein the building product has a flexural strength that is greater as compared to a building product containing no non-silicone surfactant.
11. The building product of any above embodiment, wherein the building product has a compressive strength that is greater as compared to a building product containing no non-silicone surfactant.
12. The building product of any above embodiment, wherein the building product has a compressive strength that is comparable to a building product containing no non-silicone surfactant.
13. The building product of any above embodiment, wherein the building product has a lower K-factor as compared to a building product containing no non-silicone surfactant.
15. The building product of any above embodiment, wherein the non-silicone surfactant is selected from the group consisting of non-ionic non-silicone surfactant, anionic non-silicone surfactant, cationic non-silicone surfactant, ampholytic non-silicone surfactant, semi-polar non-silicone surfactant, zwitterionic non-silicone surfactant, or combinations thereof.
16. The building product of any above embodiment, wherein the non-silicone surfactant is a non-ionic non-silicone surfactant.
17. The building product of any above embodiment, wherein the non-ionic non-silicone surfactant comprises greater than or equal to 35% Dibutylmaleate-N-vinyl-2-pyrrolidinone copolymer.
18. The building product of any above embodiment, wherein the building product is devoid of a silicone surfactant.
19. The building product of any above embodiment, wherein the polyurethane is the sole polymer system in the product.
20. The building product of any above embodiment, wherein the fly ash is present in an amount of from 40% to 60% by weight of the building product.
21. The building product of any above embodiment, wherein the fly ash is present in an amount from 45% to 55% by weight of the building product.
22. The building product of any above embodiment, wherein said fly ash is Class C or Class F fly ash.
23. The building product of any above embodiment, wherein said fly ash is Class C fly ash.
24. The building product of any above embodiment, wherein the building product further comprises one or more filler and/or additive.
25. The building product of any above embodiment, having an engineered shape selected from the group consisting of synthetic stone, roofing tiles, ceramic tiles, architectural stone, thin bricks, bricks, pavers, sheets, panels, boards, underlay, banisters, lintels, pipe, posts, signs, guard rails, retaining walls, park benches, tables, and railroad ties.
26. The building product of any above embodiment, wherein the engineered shape is a board.
27. The building product of any above embodiment, comprising Type C fly ash present in an amount equal to or greater than 50 wt % of total weight of the building product, and wherein the building product is essentially free of fiber.
28. A method of producing the building product of any above embodiment, comprising:

contacting an isocyanate and a polyol, in the presence of fly ash and 0.5% to 2.2% non-silicone surfactant by weight of the polyol, and optionally other additives and fillers, to prepare a mixture;

extruding the mixture into a mold; and

curing the mixture to obtain the building product.

29. The method of embodiment 28, further comprising shaping the foamed polyurethane building product.
30. The method of embodiment 29, wherein the mixture and the product do not contain a silicone surfactant.

### EXAMPLES

The following examples are offered by way of illustration and not by way of limitation.

### Example 1. Foamed Polyurethane Building Product

Foamed polyurethane building products were prepared. The exemplified building products comprise polyurethane comprising 50% fly ash, 0.1 pphp (0.1 wt % of the polyol) amine catalyst, and 1 pphp water (0.1 wt % of the polyol). Specifically, the exemplified polyurethanes comprise: the reaction product of a polyol and isocyanate at isocyanate index of 104; water (1 wt % of polyol); Catalyst (0.1 wt % of polyol); a Dibutylmaleate-N-vinyl-2-pyrrolidinone copolymer non-silicone surfactant (0.5-2 wt % of polyol); and Type C fly ash (50 wt % of total mixture). No fiber or other components were used in this example. The building product was prepared by contacting polyol, water, catalyst, surfactant and fly ash in a vessel equipped with a mixing apparatus, e.g., SPEEDMIXER, and mixed for approximately 45 seconds. The mixture was then contacted with MDI and mixing continued for another 45 seconds.

The building products had an engineered shape of a board.

### Example 2. Determination of Flexural Strength

The foamed polyurethane building products of Example 1 were tested to determine flexural strength. For testing purposes, a representative building product dimension was chosen as 9″ (L)×2.5″ (W)×0.5″ (D).

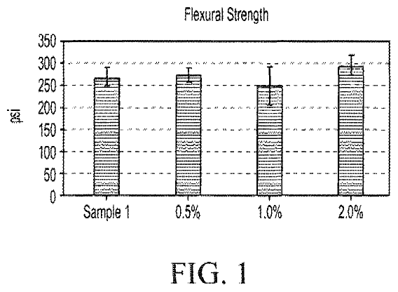

The results are shown in FIG. 1. The data show that at 0.5%, the flexural strength is similar to Sample 1; at 1.0%, the flexural strength is lower than Sample 1; and at 2.0%, the flexural strength is increased compared to Sample 1, even though a high level of surfactant is present.

The flexural strength is the load required to fracture a rectangular prism loaded in the three point bend test as described in ASTM C1185-08 or ASTM C947-03.

### Example 3. Determination of Modulus

The foamed polyurethane building products of Example 1 were tested to determine modulus. For testing purposes, a representative building product dimension was chosen as 9″ (L)×2.5″ (W)×0.5″ (D).

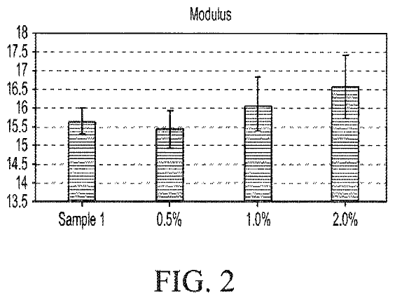

The results are shown in FIG. 2. The data show that at 0.5%, the modulus is lower as compared to Sample 1; at 1.0%, the modulus is greater as compared to Sample 1; and at 2.0%, the modulus is greater as compared to Sample 1, even though a high level of surfactant is present.

The modulus is calculated as the slope of the stress/strain curve from the three point bend test. The modulus was determined in accordance with ASTM C947-03 or ASTM C1185-08.

### Example 4. Determination of Compressive Strength

The foamed polyurethane building products of Example 1 were tested to determine compressive strength. For testing purposes, a representative building product dimension was chosen as 0.5″ (L)×0.5″ (W)×0.5″ (D).

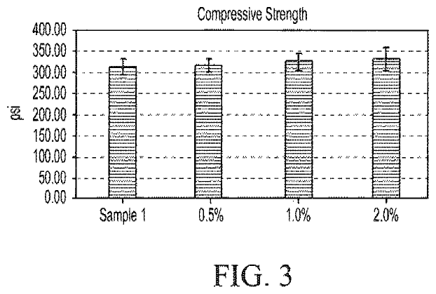

The results are shown in FIG. 3. The data show that at 0.5%, 1.0%, and 2.0%, the compressive strength is comparable to Sample 1, even though a high level of surfactant is present.

The compressive strength was determined in accordance with ASTM D1621.

### Example 5. Visual Determination of Surface Topography

The foamed polyurethane building products of Example 1 were tested for surface topography.

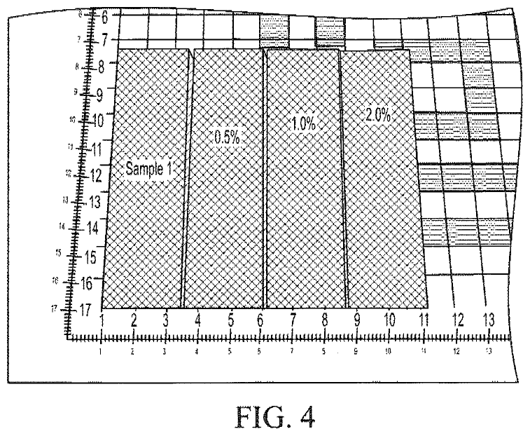

The results are shown in FIG. 4. The photograph shows that the 1.0% and 2.0% samples exhibit the desired topography. The 0.5% sample contains noticeable pinholes and is not marketable.

### Example 6. Scanning Electron Microscopy

Scanning electron microscopy (SEM) images were obtained showing the structural features of the foamed polyurethane building products of Example 1.

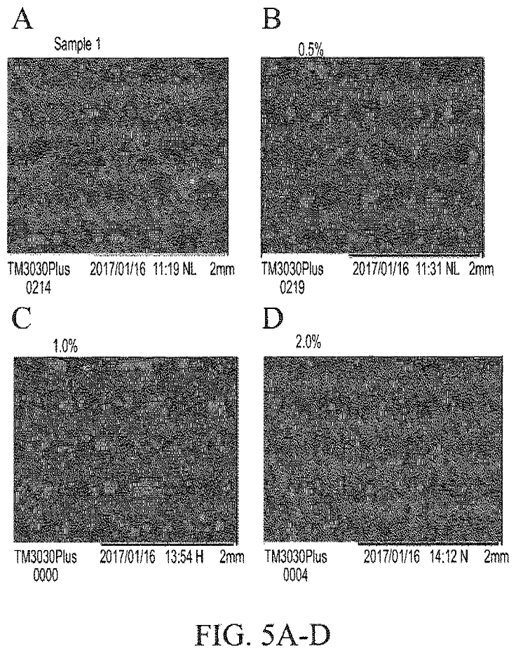

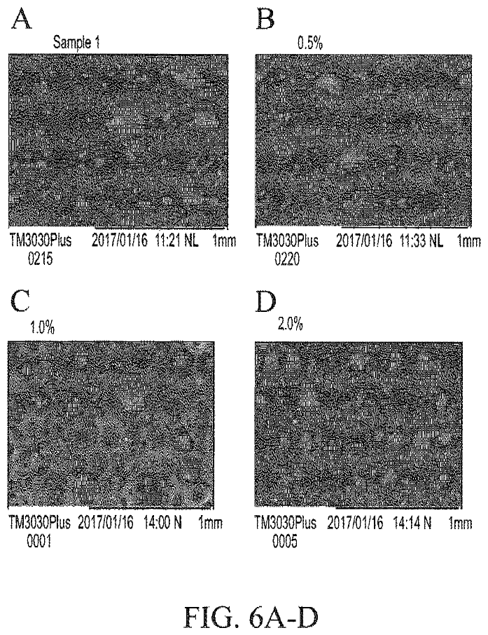

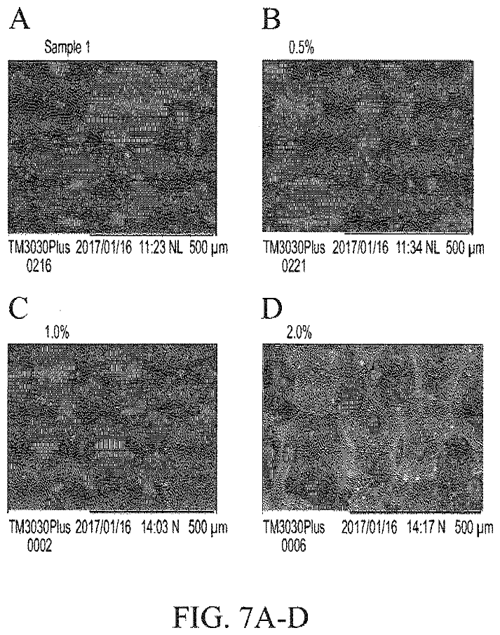

The results are shown in FIGS. 5-7. The SEM images evidence at least two significant morphological trends as the amount of non-silicone surfactant increases from 0% to 2%: 1) cell sizes of the foam become more uniform, i.e., the foam cell size distribution becomes smaller; and 2) the cell walls (boundaries between cells) become more continuous. Without being bound to theory, it is believed that these morphological properties can contribute to the improved mechanical properties, while the fine cell structure at or near the surface provides the desired surface characteristics.

It is to be noted that the term “a” or “an” entity refers to one or more of that entity; for example, “a nanoparticle” is understood to represent one or more nanoparticles. As such, the terms “a” (or “an”), “one or more,” and “at least one” can be used interchangeably herein.

Throughout this specification and the claims, the words “comprise,” “comprises,” and “comprising” are used herein synonymously with the term “including” and are used in a non-exclusive sense and except where the context requires otherwise. “Comprising” and the like are intended to mean that the compositions and methods include the recited elements, but does not exclude others. “Consisting essentially of” when used to define compositions and methods, shall mean excluding other elements of any essential significance to the combination for the stated purpose. Thus, a composition consisting essentially of the elements as defined herein would not exclude other materials that do not materially affect the basic and novel characteristic(s) of the claimed composition. A method consisting essentially of the steps as defined herein would not exclude other steps that do not materially affect the basic and novel characteristic(s) of the claimed method. “Consisting of” shall mean excluding more than trace elements of other ingredients and substantial method steps. Embodiments defined by each of these transition terms are within the scope of the subject matter described herein.

As used herein, “optional” or “optionally” means that the subsequently described event or circumstance can or cannot occur, and that the description includes instances where the event or circumstance occurs and instances where it does not.

Also as used herein, “and/or” refers to and encompasses any and all possible combinations of one or more of the associated listed items, as well as the lack of combinations when interpreted in the alternative (“or”).

All numerical designations, e.g., temperature, time, pressure, force, and concentration, including ranges, are approximations which are varied (+) or (−) by increments of 0.1 or 1.0, where appropriate. It is to be understood, although not always explicitly stated that all numerical designations are preceded by the term “about.” It also is to be understood, although not always explicitly stated, that the reagents described herein are merely exemplary and that equivalents of such are known in the art.

As used herein, unless otherwise specifically described, the terms “increase,” “increases,” “increased,” “increasing,” “improve,” “enhance,” and similar terms indicate an elevation in the specified parameter of at least about 5%, 10%, 15%, 20%, 25%, 30%, 35%, 40%, 45%, 50%, 55%, 60%, 65%, 70%, 75%, 80%, 85%, 90%, 95%, 100%, 150%, 200%, 300%, 400%, 500% or more.

Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the presently disclosed subject matter be limited to the specific values recited when defining a range.

All publications and patent applications mentioned in the specification are indicative of the level of those skilled in the art to which the subject matter described herein pertains. All publications and patent applications are herein incorporated by reference to the same extent as if each individual publication or patent application was specifically and individually indicated to be incorporated by reference.

Many modifications and other embodiments of the subject matter set forth herein will come to mind to one skilled in the art to which this subject matter pertains having the benefit of the teachings presented in the foregoing descriptions and the associated drawings. Therefore, it is to be understood that the subject matter described herein is not to be limited to the specific embodiments disclosed and that modifications and other embodiments are intended to be included within the scope of the foregoing list of embodiments and appended claims. Although specific terms are employed herein, they are used in a generic and descriptive sense only and not for purposes of limitation.

1-30. (canceled)

31. A building product comprising:
polyurethane comprising fly ash and a non-silicone surfactant,
wherein the fly ash is present in an amount of 40% to 90% by weight based on the total weight of the building product,
wherein the non-silicone surfactant is present in an amount of 0.5% to 2.2% by weight of the total building product,
wherein a surface roughness of the building product defined by a fine cell structure on the surface; and
wherein the modulus of the building product is comparable to a building product substantially free of the non-silicone surfactant.

32. The building product of claim 31, wherein the polyurethane comprises fine closed-cell structure.

33. The building product of claim 31, wherein the non-silicone surfactant is present in an amount from 0.7% to 2.0% by weight of the total building product.

34. The building product of claim 31, wherein the non-silicone surfactant is present in an amount from 1.0% to 2.0% by weight of the total building product.

35. The building product of claim 31, wherein the building product has a modulus from 16 to 17 ksi.

36. The building product of claim 31, wherein the building product has a modulus that is from 3% to 7% higher as compared to a building product containing no non-silicone surfactant.

37. The building product of claim 36, wherein the building product has a modulus that is from 5% to 7% higher as compared to a building product containing no non-silicone surfactant.

38. The building product of claim 31, wherein the building product has a flexural strength from 200 to 350 psi.

39. The building product of claim 38, wherein the building product has a flexural strength of 250 to 300 psi.

40. The building product of claim 31, wherein the building product has a flexural strength that is greater as compared to a building product containing no non-silicone surfactant.

41. The building product of claim 31, wherein the building product has a compressive strength that is greater as compared to a building product containing no non-silicone surfactant.

42. The building product of claim 31, wherein the building product has a compressive strength that is comparable to a building product containing no non-silicone surfactant.

43. The building product of claim 31, wherein the building product has a lower K-factor as compared to a building product containing no non-silicone surfactant.

44. The building product of claim 31, wherein the non-silicone surfactant is selected from the group consisting of a non-ionic non-silicone surfactant, anionic non-silicone surfactant, cationic non-silicone surfactant, ampholytic non-silicone surfactant, semi-polar non-silicone surfactant, zwitterionic non-silicone surfactant, and combinations thereof.

45. The building product of claim 44, wherein the non-silicone surfactant is a non-ionic non-silicone surfactant.

46. The building product of claim 45, wherein the non-ionic non-silicone surfactant comprises equal to or greater than 35% Dibutylmaleate-N-vinyl-2-pyrrolidinone copolymer.

47. The building product of claim 31, wherein the building product is devoid of a silicone surfactant.

48. The building product of claim 31, wherein the polyurethane is the sole polymer system in the building product.

49. The building product of claim 31, wherein the fly ash is present in an amount from 40% to 60% by weight of the building product.
